(19) United States
(12) Patent Application Publication
(10) Pub. No.: US 2015/0078142 A1
(43) Pub. Date: Mar. 19, 2015

(54) ENVIRONMENT-RESOLUTION CORRELATED TIMER

(71) Applicant: Loominocity, Inc., Napa, CA (US)

(72) Inventor: Jason Loomis, Decatur, GA (US)

(73) Assignee: Loominocity, Inc., Napa, CA (US)

(21) Appl. No.: 14/032,001

(22) Filed: Sep. 19, 2013

(51) Int. Cl. G04F 10/00; G04G 9/04

(52) U.S. Cl. CPC G04F 10/00; G04G 9/04
USPC 368/107

(57) ABSTRACT

Apparatus and associated methods relate to a timer having multiple time resolutions corresponding to multiple environmental climates. Climates may include, for example, temperature, humidity, pressure, or any of these taken alone or in combination. Climates may include, for example, carbon monoxide content, oxygen content, toxic gases, or any of these taken alone or in combination. The resolutions and climates may be particular to selected applications, including but not limited to, perishable foods, chemicals (e.g. alcohol, cement, pharmaceuticals), or perishable evidence (e.g. crime scene materials). In one embodiment, a breast-milk timer may have three times scales, an hourly scale corresponding to room-temperature environment, a daily scale corresponding to refrigeration, and a monthly scale corresponding to a freezer environment. As time elapses, the timer may automatically transition from the hourly scale to the daily scale and then to the monthly scale. Such a timer may quickly communicate breast milk freshness.

### TECHNICAL FIELD

Various embodiments relate generally to timing devices, and specifically to multiple-resolution timers.

### BACKGROUND

Timers are used in a great many applications. Some timers, such as cooking timers are count-down timers. Other timers, such as stop-watches are elapsed-time or count-up timers. Elapsed-time counters may begin operation automatically, such as when a computer signal is received and others may require an operator to initiate the timer. Elapsed-time counters may be remotely located from the object that is being timed. For example, a cook may have a casserole and bread simultaneously cooking in the oven. An oven timer may be set to count-down until the bread is done cooking. But the cook may not remember which item is being timed. Furthermore, the cooking time required for the bread may vary depending on environmental conditions. For example, a different cooking temperature may require longer or shorter cooking time. Different humidities or altitudes, for example, may also affect the cooking time.

Some temporal hazards may be associated with different climate environments. For example, food perishes at different times, depending upon the climate environment. Dairy products, for example have a limited shelf life at room temperature conditions. But if refrigerated, dairy products may last for days, and perhaps even weeks. Some dairy products, such as cheese, milk, or butter, may be frozen. Frozen dairy products may have a long shelf life before spoiling. Spoilage of dairy products has a temporal hazard that varies with environmental conditions.

### SUMMARY

Apparatus and associated methods relate to a timer having multiple time resolutions corresponding to multiple environmental climates. Climates may include, for example, temperature, humidity, pressure, or any of these taken alone or in combination. Climates may include, for example, carbon monoxide content, oxygen content, toxic gases, or any of these taken alone or in combination. The resolutions and climates may be particular to selected applications, including but not limited to, perishable foods, chemicals (e.g. alcohol, cement, pharmaceuticals), or perishable evidence (e.g. crime scene materials). In one embodiment, a breast-milk timer may have three times scales, an hourly scale corresponding to room-temperature environment, a daily scale corresponding to refrigeration, and a monthly scale corresponding to a freezer environment. As time elapses, the timer may automatically transition from the hourly scale to the daily scale and then to the monthly scale. Such a timer may quickly communicate breast milk freshness.

Various embodiments may achieve one or more advantages. For example, some embodiments may permit the use of a single timer for multiple climate environments. A timer may be removably attached to a perishable food which may be stored at room temperature, refrigerated, or stored in a freezer. In some embodiments, colored LEDs may indicate the elapsed time with the color indicative of temporal proximity to expiration. In some embodiments, the multiple time resolutions may be separated on the face of the timer device to facilitate ease of identification. Some exemplary environment-resolution correlated timers may provide the functionality of multiple timers. Some embodiments may provide a visual safe storage indicator without requiring an action by the user. Various exemplary elapsed-time counters require no math of the user. In some embodiments, the timers may be sealed facilitating cleaning.

In various embodiments, the timers may be used for multiple different products. Exemplary attachment devices may present a single timer coupling interface, which may make facilitate their use. For example, a milk container screw top attachment device may replace standard mild container screw tops and permit the timing of fresh milk storage. Users may require instruction for only one timing device for timing multiple temporal hazards.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary storage timing application of an exemplary perishable-food timer.

FIG. 2 depicts a perspective view of an exemplary multiple-environmental-climate timer.

FIG. 3 depicts a perspective view of an exemplary multiple-environmental-climate timer.

FIG. 4 depicts a plan view of an exemplary multiple-environmental-climate timer.

FIG. 5 depicts a perspective view of an exemplary multiple-environmental-climate timer.

FIG. 6 depicts a perspective view of exemplary baby-bottle timers on baby-bottle caps.

FIG. 7 depicts a perspective view of an exemplary attachment band for an exemplary multiple-environmental-climate timer.

FIG. 8 depicts a block diagram of an exemplary embodiment of a multiple-time-scale timer.

FIG. 9 depicts a state diagram of an exemplary multiple-time-scale device.

FIG. 10 depicts a block diagram of an exemplary time-scale programmable wireless timing system.

Like reference symbols in the various drawings indicate like elements.

### DETAILED DESCRIPTION OF ILLUSTRATIVE EMBODIMENTS

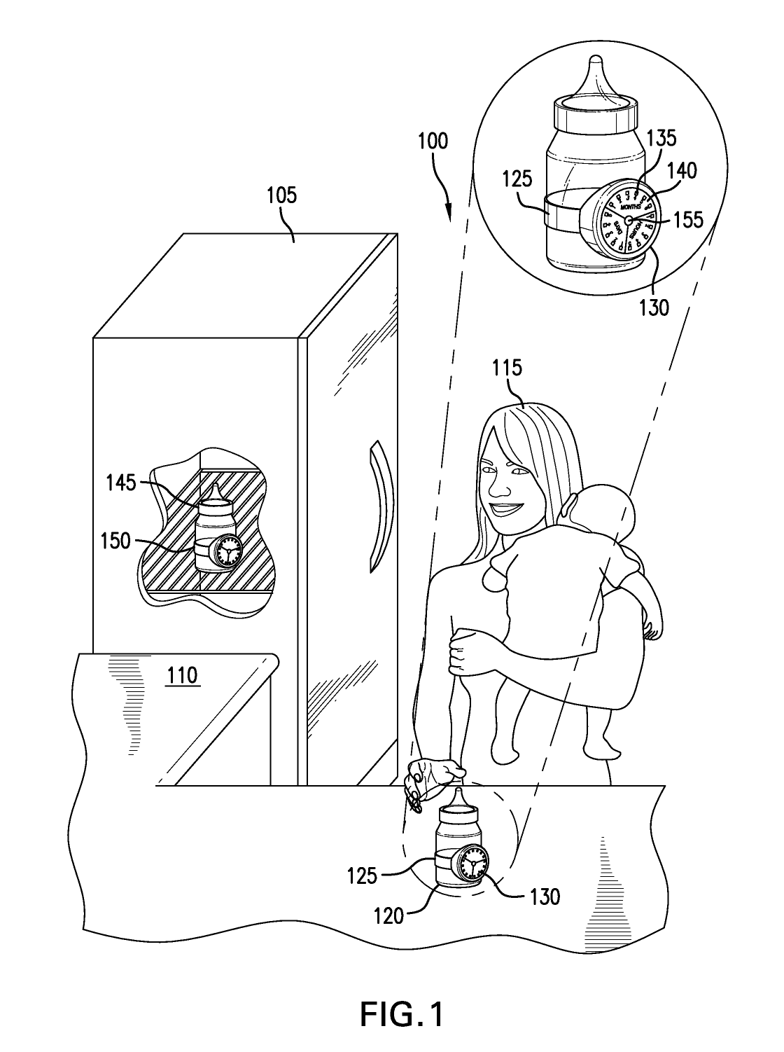

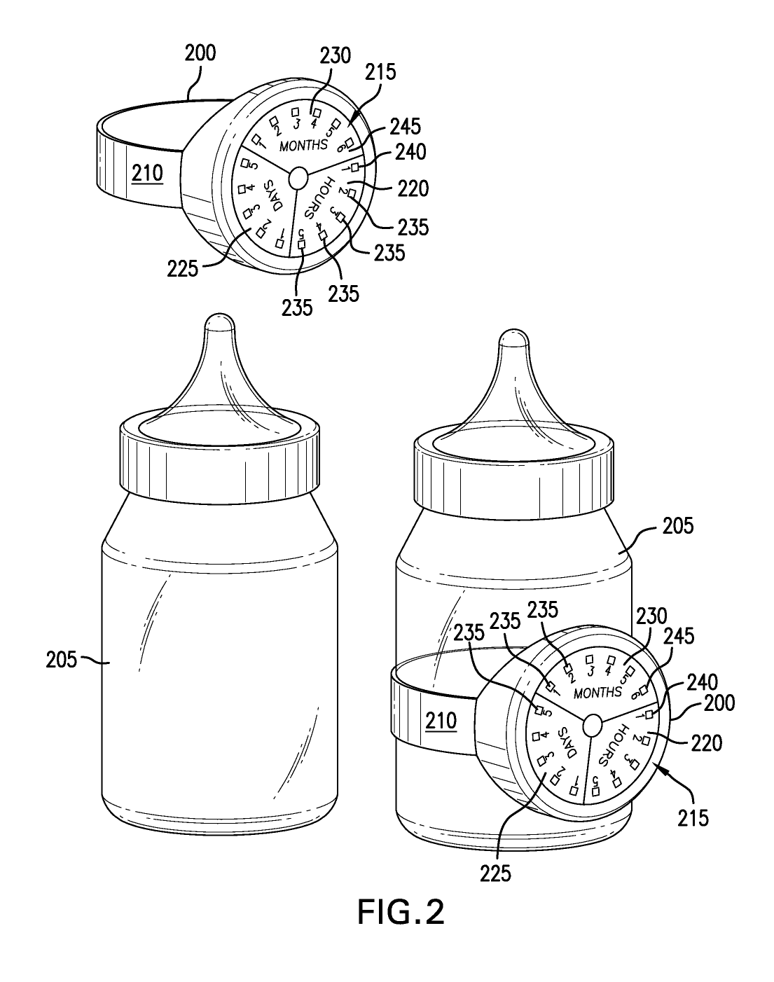

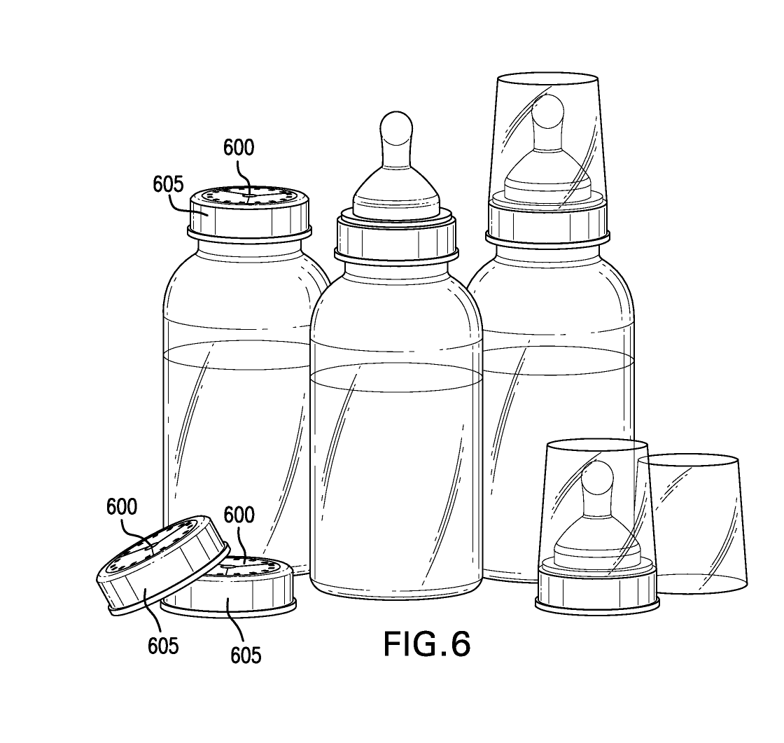

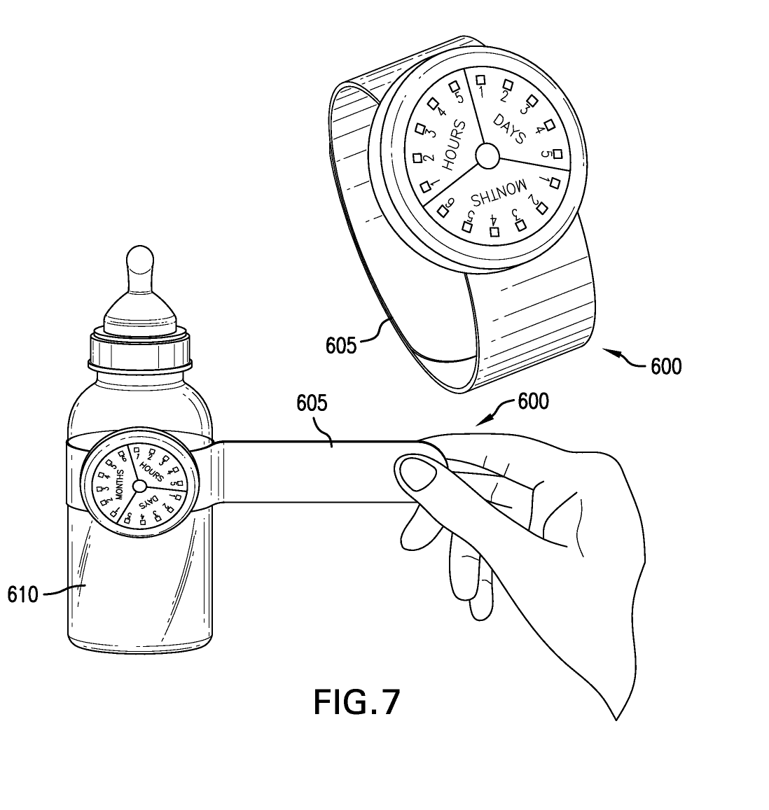

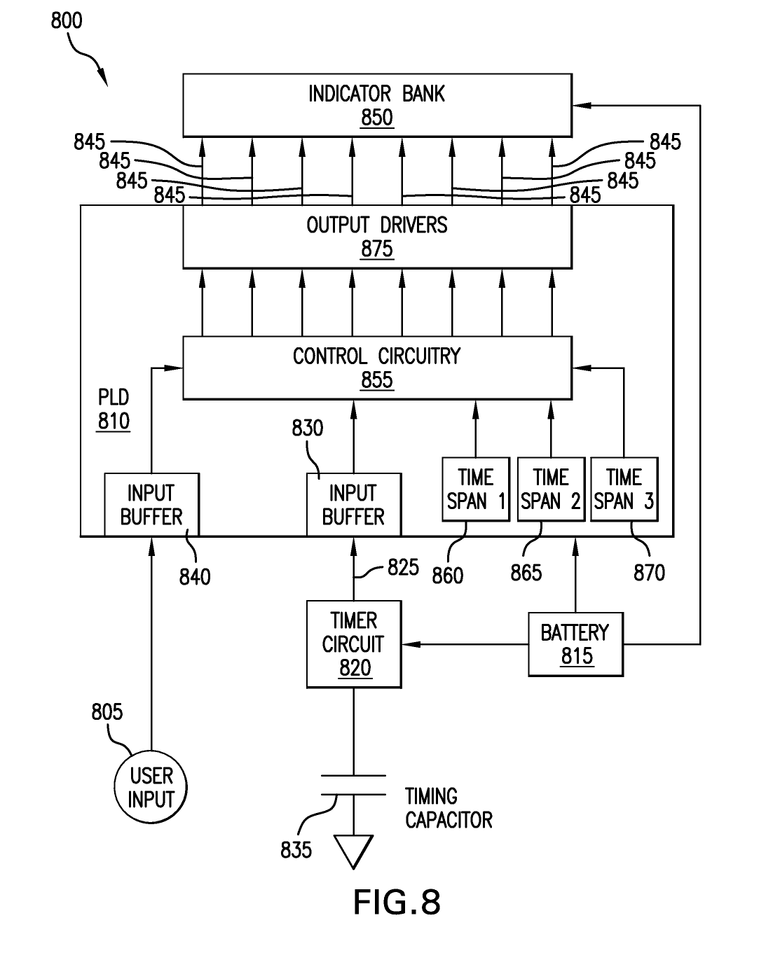

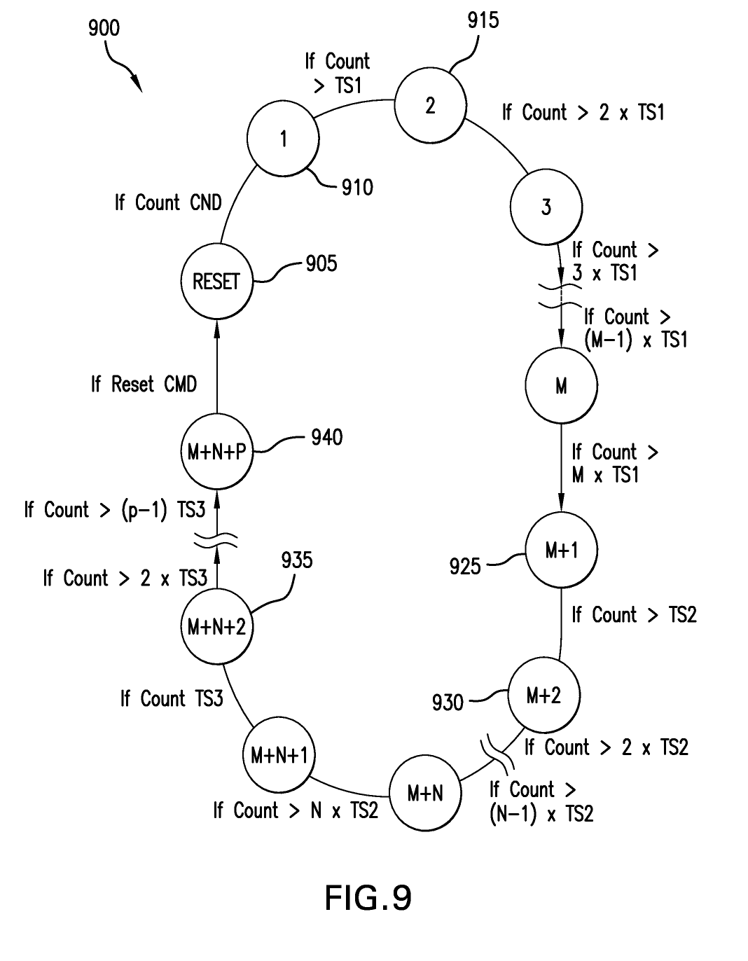

To aid understanding, this document is organized as follows. First, an exemplary application of an exemplary perishable-food timer is briefly introduced with reference to FIG. 1. Second, with reference to FIGS. 2-5, the discussion turns to exemplary embodiments that illustrate various aspects of exemplary multi-environmental-climate food timers. Then, with reference to FIG. 6, exemplary timer attachment mechanisms will be discussed. Discussion then turns to exemplary system embodiments of multiple time-span timing systems. With reference to the block diagram of FIG. 7, a survey of system architectures will be discussed. Then with reference to FIG. 8 an exemplary control system will be detailed by way of a state diagram. Finally, with reference to FIG. 9 an exemplary wireless implementation of a programmable multi-resolution timer will be described.

FIG. 1 depicts an exemplary storage timing application of an exemplary perishable-food timer. In this figure, a kitchen 100 includes a refrigerator 105 and a counter-top 110. A woman 115 is reaching for baby bottle 120 on the counter-top 110. The baby bottle 120 has an attached exemplary perishable-food timer 125. The attached perishable-food timer 125 has a display face 130. As the woman 115 reaches for the baby bottle 120, a flashing colored Light Emitting Diode (LED) 135 may indicate the storage condition of the bottle's contents. A flashing green colored LED located in an “Hours” section 140 of the display face 130, for example, may immediately communicate to the woman 115 that the contents of the bottle 120 have been stored for a safe storage time associated with room-temperature storage, such as being stored on the counter-top 110. The display face 130 may have a section corresponding to refrigeration as well. Inside the refrigerator 105 is another baby bottle 145 which also has an attached perishable-food timer 150. Should the woman 115 open the refrigerator 105 and see the perishable-food timer 150, she may immediately know whether the stored contents of the baby bottle 145 may be safe from spoilage by the color and location of a flashing LED. Each perishable-food timer 120, 150 may begin counting elapsed time when a control button 155 in the center of the display face 130 is depressed. The perishable-food timers 120, 150 may begin by flashing the “1 Hour” LED, and then sequence through the other LEDs as the time elapses. The “1 Day” LED may begin to flash immediately after five hours of elapsed time which may coincide with the time when the “5 Hours” LED terminates flashing. And the “1 Month” LED may be activated after five days have elapsed which may coincide with when the “5 Days” LED terminates flashing. In this way, all three time scales, “Hours,” “Days,” and “Months” are initiated simultaneously with the push of the control button 155.

FIG. 2 depicts a perspective view of an exemplary multiple-environmental-climate timer 200. In the FIG. 2 embodiment, an exemplary multiple-environmental-climate timer 200 is depicted both before attachment and after attachment to a baby bottle 205. The multiple-environmental-climate timer 200 attaches to the baby bottle 205 using an elastic band 210, in this exemplary embodiment. The elastic band 210 may circumscribe the circumference of the baby bottle 205. A display face 215 of the multiple-environmental-climate timer 200 may communicate the elapsed time of storage. The multiple-environmental-climate timer 200 is depicted with the display face 215 having three different environmental climate zones 220, 225, 230. Each of the environmental climate zones 220, 225, 230 has a plurality of elapsed-time indicators 235. In some embodiments, the elapsed-time indicators 235 may be ordered from a first elapsed-time indicator 240 to a last elapsed-time indicator 245. Each elapsed-time indicator 235 may be associated with a time span. For example, the first elapsed-time indicator 240 may be associated with a time span starting upon timer activation (e.g. zero hours), and ending when the elapsed time is one hour. The next elapsed-time indicator may be associated with a time span beginning at one hour of elapsed time and ending at two hours of elapsed time. In some embodiments, the first of two adjacent-in-time elapsed-time indicators may be associated with a time span having an ending elapsed time which is equal to a beginning elapsed time of a time span associated with the second of two adjacent-in-time elapsed-time indicators. In some embodiments, the time spans may have different durations and/or different units. Each time span may be defined by a beginning elapsed time and an ending elapsed time.

In various embodiments, after the elapsed time becomes greater than the ending elapsed time of the time span associated with the last timing indicator of the first environmental climate zone, the first timing indicator of the second timing zone may become active. In this way, the multiple-environmental-climate timer 200 may automatically transition from timing the hazard associated with one environmental climate zone to timing the hazard associated with another environmental climate zone. This transition may not require a user to perform any operation on the multiple-environmental-climate timer 200.

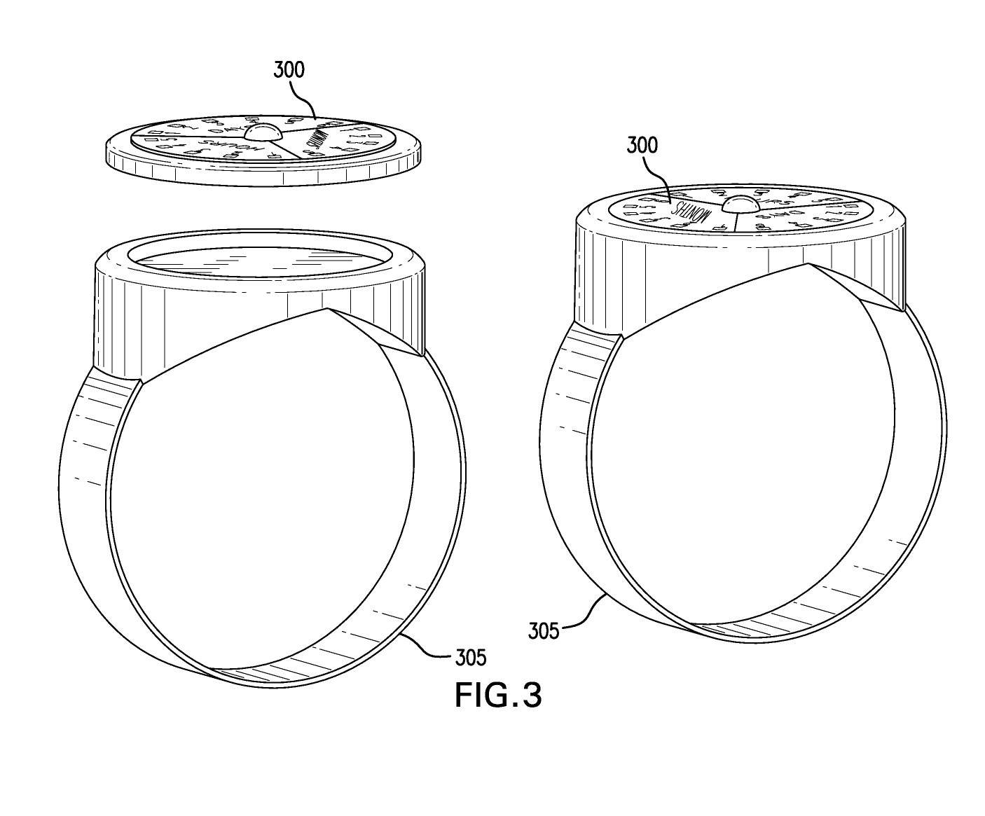

FIG. 3 depicts a perspective view of an exemplary multiple-environmental-climate timer. The FIG. 3 embodiment depicts the timer display both detached and attached to a connecting device 305. The connecting device shown in FIG. 3 may connect the timer to a baby bottle, for example. Other connecting devices may connect the timer to food products having different shaped containers. For example, a milk timer may have a milk-container screw-cap attachment device which may replace the standard milk container's screw cap. An egg timer may have an attachment device that attaches to a standard-sized egg carton, for example. Such connecting devices may present a common means for connecting a timer to the connecting device. In this way, a timer may be used for multiple perishable food objects.

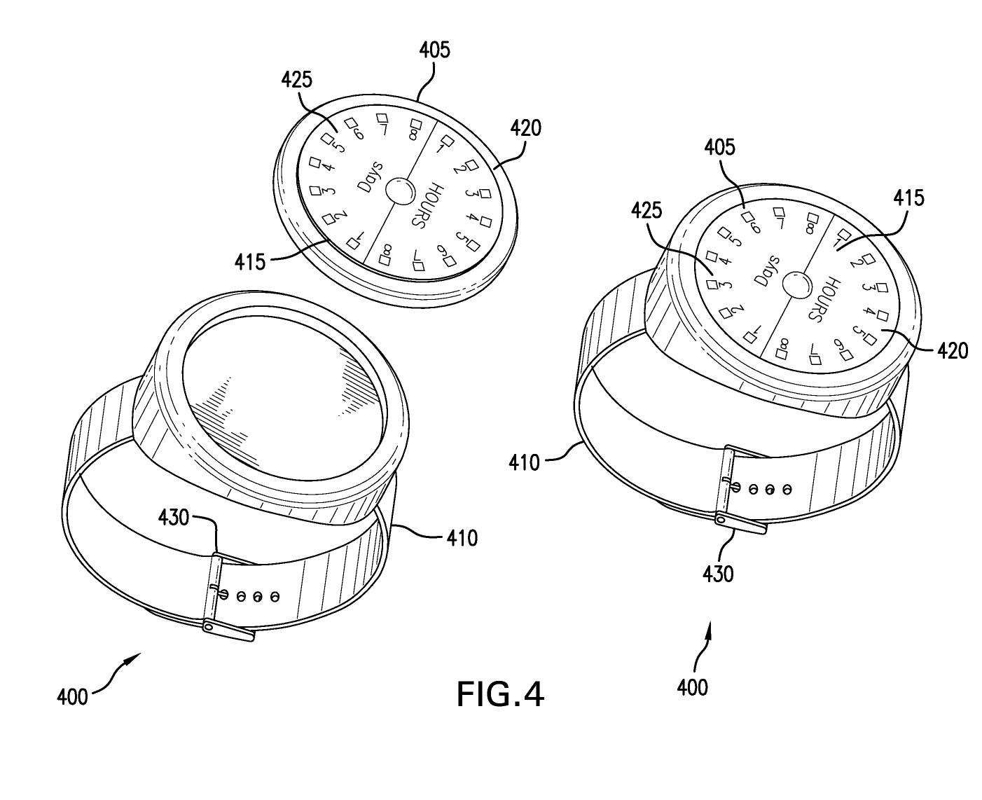

FIG. 4 depicts a perspective view of an exemplary multiple-environmental-climate timer 400. In this figure, an exemplary multiple-environmental-climate timing device 405 is depicted both attached to and separated from an exemplary attachment band 410. The multiple-environmental-climate timing device 405 may be releasably attached to the attachment band 410. When the multiple-environmental-climate timing device 405 is released from the attachment band 410, for example, a user may be able to replace a battery. The multiple-environmental-climate timing device 400 may be removed from the attachment band 410 for cleaning purposes, for example. Some exemplary embodiments of multiple-environmental-climate timing devices 405 may be sealed which may facilitate cleaning of the multiple-environmental-climate timing devices 405.

In the FIG. 4 embodiment, an exemplary display face 415 has two different environmental-climate regions 420, 425. Each of the environmental-climate regions 420, 425 may have a different time-scale associated with it. For example, a high-altitude environmental climate environment may have one time scale and a sea-level environmental climate may have another time scale. A high-humidity environment may have a different time-scale, for example, than that of a low-humidity environment.

In the FIG. 4 embodiment, the attachment device 410 is depicted as having a buckle 430. Various embodiments may use different means for attaching a timer to an object. Some embodiments may one of a variety of different buckle mechanisms to attach the timer to the object. Some embodiments may permit the attachment device to attach to different sized objects by implementing an attachment mechanism that accommodates different objects having different dimensions.

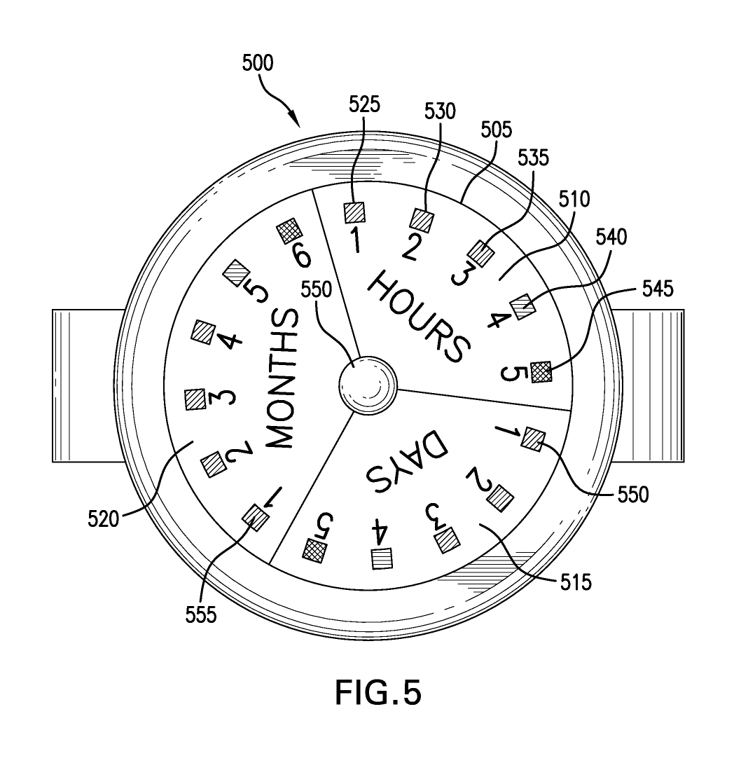

FIG. 5 depicts a plan view of an exemplary multiple-resolution timer. In this figure, an exemplary breast-milk timer 500 is shown in a plan view. The depicted breast-milk timer 500 has an exemplary display face 505. In the depicted embodiment the display face 505 has three regions 510, 515, 520, an hour region 510, a day region 515 and a month region 520. The hour region 510 may be associated with the safe storage times for room-temperature storage of breast milk, for example. The day region 515 may be associated with the safe storage times for refrigerated storage of breast milk, for example. The month region 520 may be associated with the safe storage times for frozen storage of breast milk, for example. Different numbers of regions may be used in different embodiments. For example, some timers may have two different display face regions. One may be associated with a refrigerated environment, for example. One of the display face regions may be associated with a frozen storage environment, for example. Some embodiments may have four or more environmental regions on the display face.

In the FIG. 5 embodiment, the hour region 510 has five hourly timing indicators 525, 530, 535, 540, 545. The exemplary display face 505 also has a control button 550 in the center. In some embodiments, the control button 550 may be pushed to signal a begin-count signal to a multiple-resolution timer 500. The multiple-resolution timer 500 may respond to the begin-count signal by flashing a first timing indicator labeled “1,” 525 in the “HOURS” region 510 of the display face 505. After one hour elapses, the timing indicator labeled “1” 525 may stop flashing and the timing indicator labeled “2” 530 in the “HOURS” region 510 may begin to flash. Then after two hours have elapsed, the timing indicator labeled “2” 520 may stop flashing and the timing indicator labeled “3” 535 in the “HOURS” region 510 may begin to flash. After another hour has elapsed, the timing indicator labeled “3” 535 may stop flashing and the timing indicator labeled “4” 540 in the “HOURS” region 510 may begin to flash. Again after four hours have elapsed since the begin-count event, the timing indicator labeled “4” 540 may stop flashing and the timing indicator labeled “5” 545 in the “HOURS” 510 region may begin to flash. In this way, the flashing indicator sequences through the timing indicators.

Note that in this exemplary display, the first three LEDs 525, 530, 535 labeled “1,” “2,” and “3” in the “HOURS” region 510 are green colored, while the LED labeled “4” 540 in the “HOURS” region 510 is yellow and the LED labeled “5” 545 in the “HOURS” region 510 is red. These colors may represent the temporal proximity to spoilage when breast milk is stored at room temperature, for example. A red colored LED may indicate that the breast milk may be close to the safe time-limit of storage in this environment, for example. A yellow may indicate a more remote temporal-distance from the spoilage of the breast milk, for example. And green LEDs may indicate an even more remote temporal-distance from spoilage.

After five hours of elapsed time, the timing indicator labeled “5” 545 in the “HOURS” region 510 of the display face 505 may stop flashing and the timing indicator labeled “1” 550 in the “DAYS” region 515 of the display may begin to flash. The timing indicators in the “DAYS” region 515 may sequence in a similar fashion to those of the “HOURS” region 510, but with a daily transition instead of an hourly transition. The then after five days have elapsed, the first timing indicator labeled “1” 555 in the “MONTHS” region 520 of the display face 505 may begin to flash. Again the color of the timing indicators may indicate the temporal proximity to spoilage, but with regard to a different time resolution corresponding to a different climate and/or environment.

Some embodiments may have multiple time resolutions within a single display region. For example, a timing indicator in the “HOURS” region 510 may be labeled “4-5,” which may indicate that the elapsed time is greater than 3 hours but less than 5 hours. In some embodiments, instead of having three separate green LEDs labeled “1,” “2,” and “3,” a single green LED may be labeled “1-3” for example.

FIG. 6 depicts a perspective view of exemplary baby-bottle timers on baby-bottle caps. In the FIG. 6 embodiment, baby-bottle timers 600 are on the flat external face of the baby-bottle caps 605. In some embodiments, the baby-bottle timer 600 may begin timing when shaken, such as for example when formula is mixed in a capped bottle. In some embodiments, the baby-bottle timer 600 may have an integral temperature sensor. The baby-bottle timer 600 may use the temperature sensor to calculate the spoilage rate at the measured temperature. The baby-bottle timer 600 may then adaptively adjust spoilage indicators on the face of the baby-bottle timer 600 to indicate how close to spoilage the contents may be.

FIG. 7 depicts a perspective view of an exemplary attachment band for an exemplary multiple-environmental-climate timer. In the depicted exemplary embodiment, the means for attaching the multiple-environmental-climate timer 700 is shown to be a snap-band. A snap-band 705 may be simply snapped to the bottle for attachment. In this exemplary figure, the snap-band 705 is depicted as being attached to a wrist 710. An end 715 of the snap-band 705 may be pulled to remove the multiple-environmental-climate timer 700 from a bottle, for example. Other attachment means may be used in other embodiments. For example, some embodiments may use disposable cable ties for attachment. Some embodiments may use adhesives for attaching a timer to a timed object. Magnets may be used to attach a timer to a metal container. Metal disks with adhesive backs may attach to a product and then the magnetic timer may simply affix to the disk which is affixed to the product to be timed.

FIG. 8 depicts a block diagram of an exemplary embodiment of a multiple-time-scale timer. In the FIG. 8 embodiment, an exemplary multiple-time-scale timer 800 includes a user input device 805 connected to a Programmable Logic Device (PLD) 810, via an input buffer 840. A battery 815 provides power for the multiple-time-scale timer 800. A timer circuit 820 generates a clock signal on node 825. The clock signal is then received as an input to the PLD 810 at an Input buffer 830. A timing capacitor 835 connects to the timer circuit 820. The capacitance value of the timing capacitor 835 may be used in determining the frequency of the clock signal. The PLD 810 provides drive signals for an indicator bank 850 on an array of drive nodes 845. The input buffers 830, 840 buffer the clock signal and the user input signal, respectively, and provide these signals to a control circuit 855. The control circuit receives multiple time span settings from internal memory locations, 860, 865, 870. The control circuit generates signals for the output drivers 875 using the various inputs.

FIG. 9 depicts a state diagram of an exemplary multiple-time-scale device. In FIG. 9, a state diagram 900 may represent the operation of the control circuit 855 of the exemplary multiple-time-scale timer 700 depicted in FIG. 7. Upon power-up, the control circuit may be in a reset state 905. The control circuit may transition to state 910 which may illuminate a first LED if a count command is issued by a user, for example by pressing a button. In state 1, a counting of the clock pulses may initiate. The control system may then transition to state 915 if the clock count exceeds a first-time-span count. In state 915, a second LED may be illuminated and the first LED turned off. The control system may then transition to state 920 if the clock count exceeds two times the first-time-span count. In the state 920, a third LED may be illuminated and the second LED turned off. This sequencing of states may continue to the (M+1) state 925, which may result when the clock count exceeds M times the first-time-span count. In this state, an (M+1)^{th} LED may be illuminated and an M^{th} LED may be turned off.

The control system may then transition from state 925 to state 930 when the clock count exceeds a second-time-span count. In the state 930, an (M+2)^{th} LED may be turned on and the (M+1)^{th} LED turned off. This newly illuminated LED may represent the first LED located in a new region of a display face, for example. The LEDs located in this new region may transition with a period of the second-time-span count, rather than those previously illuminated LEDs which transitioned with a period of the first-time-span count. Finally, a third series of LEDs may be illuminated when the control system enters state 935. To transition from the last state in which the last LED located in the third series to a reset condition, a user must issue a reset command

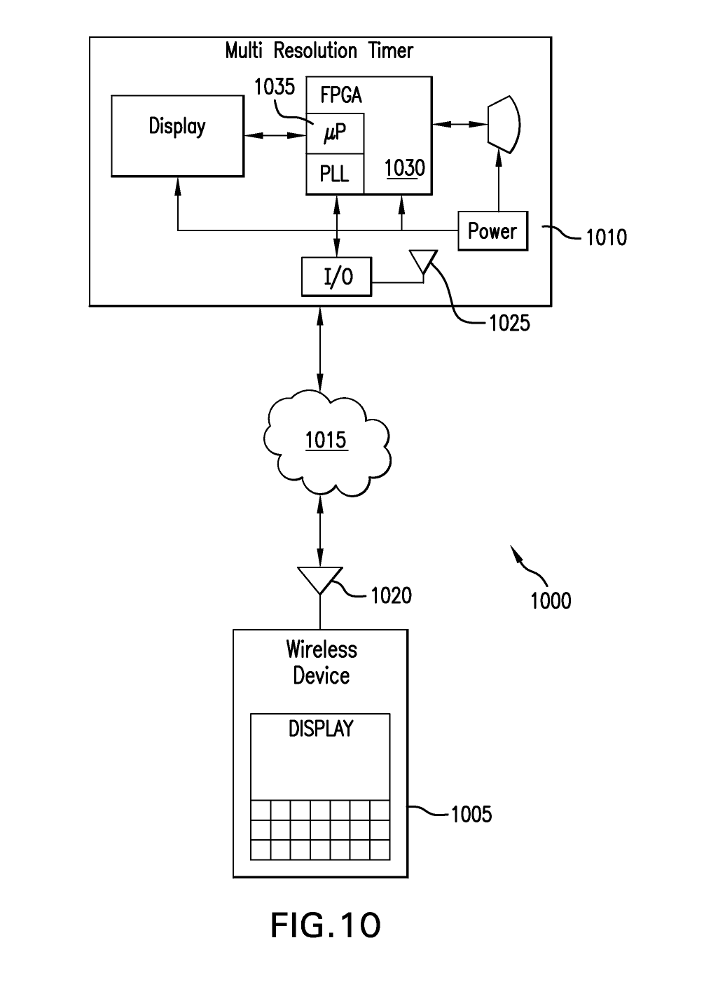

FIG. 10 depicts a block diagram of an exemplary time-scale programmable wireless timing system. In the FIG. 10 embodiment, a system for performing multiple-time-scale timing 1000 includes a wireless device 1005 and a wireless multiple-resolution timer 1010. The wireless device 1005 may be a handheld device, for example. In some embodiments, the wireless device 1005 may be a wireless phone. In some embodiments the wireless device 1005 may be a computer tablet device. The wireless device 1005 may run an application (APP) which may provide programmability to the wireless multiple-resolution timer 1010. In this figure, the wireless device 1005 is communicating to the wireless multiple-resolution timer 1010 via a cloud 1015. In some embodiments, the wireless device 1005 may directly communicate with the wireless multiple-resolution timer 1010. For example the two devices 1005, 1010 may establish a direct communications link using Bluetooth. In some embodiments the two devices 1005, 1010 may establish a direct communications link using Wi-Fi. Wireless USB may be used for one or more communications links, for example. The wireless device 1005 may receive timing parameters from user input. The timing parameters may include the number of time spans. Other programmable timing parameters may include the timing duration of each of the time spans. The sequence of the time spans may be programmable.

The wireless device 1005 may then transmit the timing parameters to the wireless multiple-resolution timer 1010 via an antenna 1020. The wireless multiple-resolution timer 1010 may then receive the signal via an antenna 1025. The wireless multiple-resolution timer 1010 may then process the communications using an FPGA 1030. The FPGA 1030 may have a soft processing core 1035 for processing program instructions, for example. The processor 1035 within the FPGA 1030 may use the received timing parameters and begin timing operation. As each programmed time span event is counted, the FPGA 1030 may transmit an event response to the wireless device 1005. The APP on the wireless device 1005 may generate an audible signal for the user in response to the received event response.

Although various embodiments have been described with reference to the figures, other embodiments are possible. For example, some embodiments may use low power timing circuits such as low-power CMOS implementations of the 555 timer. In some embodiments, low power PLDs may be used. IGLOO devices are one such exemplary low-power PLD device. In some embodiments, FPGAs may be used to perform one or more of the timing operations. Some FPGA devices may employ Voltage Controlled Oscillators to generate the timing signals. Other FPGA devices may use Phase Lock Loops (PLLs) to generate a clock operation, for example. Some embodiments may generate a clock with an astable self-oscillating circuit. In some embodiments the oscillation frequency may be determined by the selection of a capacitor. In some embodiments, a resistor value may be used in determining the timing frequency of a circuit.

In some embodiments multiple control input devices may be used. In some embodiments only a single control input device may be included. Various embodiments may permit a user to begin the timer by using the control input device or devices to signal to the timer a begin-count signal. For example, in some embodiments a simple push of a button my designate begin-count to a timer. In some embodiments a subsequent push of the button may designate a light-indicate signal. Such a signal may designate a control processor to illuminate an active LED, for example. In some embodiments, if the user pushes and holds a control button, a reset-timer signal may be issued to a processor. Other control signals may be used in various embodiments. And other means for generating signals may be used in various embodiments. For example, some embodiments may have two control buttons. For example, if a user pushes both control buttons simultaneously, the timer may be issued a reset-timer signal. In some embodiments, a switch may control power, for example.

Some embodiments may employ different types of display elements. For example, a mechanical display hand may sweep through each of a plurality of display regions in a serial fashion. In an exemplary embodiment, a display face may have an LCD element. The LCD element may display a virtual display hand sweeping through each of the display regions for, example. In an exemplary embodiment, the virtual display hand may change colors as the hand sweeps through one or more of the display zones.

Various embodiments may use various methods of supplying power to a timing device. In some embodiments, a battery may be used for this purpose. For example, alkaline batteries may be used. In some embodiments, lithium batteries may be used. In an exemplary embodiment a silver oxide battery may be used. Some embodiments may include a watch battery for as a power source. An exemplary embodiment may permit recharging of a battery, or a super-capacitor for operable power. Some embodiments may permit a user to charge the device by simply shaking the timer. In some low-power embodiments, an RF receiver may couple stray RF signals and use these received signals as a power source.

Various embodiments may include a non-timing sensor. Some embodiments may use the non-timing sensor as the metric for controlling the display. For example, a toxic gas sensor may have three different display regions, an acute exposure region, a daily exposure region, and a life-time exposure region. Display indicators in each of the regions may show accumulated exposure to the toxic gas, instead of elapsed time. An exemplary toxic gas timer may indicate concentration of toxic gas for different exposure regions. For example a small concentration of toxic gas may be safe when compared with the acute threshold, moderately when safe compared with the daily exposure threshold, but unsafe when compared with the chronic exposure level, for example. Some embodiments may have a carbon monoxide sensor. In an exemplary embodiment, an Arsine sensor may be included.

An exemplary embodiment may have a radiation detector. Again, the timer may have the different display regions of the toxic gas monitor: an acute exposure region, a daily exposure region, and a life-time exposure region, for example. Some applications may have asphyxiation hazards. For example, although carbon dioxide and/or nitrogen are not toxic, if an atmosphere has too much of these gases and too little oxygen, a person could be injured or killed. Various embodiments may have a carbon dioxide detector, for example. Some embodiments may have a nitrogen detector. Some embodiments may simply use an oxygen detector to determine the presence of oxygen in the atmosphere.

In some embodiments, the non-timing sensor may be used to supplement the timer. For example, a temperature sensor may be used to select which display region is active. In some embodiments, a temperature sensor reading below the freezing temperature of water may cause the timer to use the display indicators located in a frozen environmental section of the display face, for example. In such an embodiment, the timer may still govern which of the multiple display indicators in the frozen section is active, for example.

In some embodiments, an oxygen sensor may be used in conjunction with storing an open bottle of wine. After a bottle of wine is opened, the wine may begin to oxidize. Some wines may improve with some oxidation. Some wines may go bad after too much oxidation. The timing face may have a series of indicators corresponding to the quality of the wine as a function of exposure time to oxygen. In some embodiments, a temperature sensor may be included in the timer. The oxidation rate may vary with temperature. There may be a number of different wine profiles stored in a memory of the timer. A user may select the wine profile desired to begin the timer, for example. The timer face may indicate the drinkable life of the wine, for example. The timer may be attached to an after-open wine cap, for example. The timer may control an air valve to control the exposure of the wine to oxygen, in some embodiments. Some spirits, such as for example Vintage Ports may have a long drinkable lifetime after opening. Such a timer may permit a person have confidence in drinking the spirit long after initial opening.

Various embodiments may be used for indicating the safe storage time for pharmaceutical products, for example. Medicine bottles may have a timer that begins running at the time of pharmaceutical manufacture. The medicine bottle may indicate the condition of the medicine when a user pushes a button, for example. If the medicine is temperature sensitive a temperature sensor may be included in the timer. If the medicine is humidity sensitive, a humidity sensor may be included in the timer. The timer may have a medicine profile in a memory. The timer may indicate the remaining usable lifetime of the medicine on a display, for example.

In some embodiments, the timer may be used in conjunction with a chemical process. For example, the curing of cement may be timed. In some embodiments various humidity environments may change the curing time of cement. Many chemical processes may have a timing requirement for proper cure. A chemical timer may have a simply adhesive to affix the timer to near the chemical reaction, for example.

Another embodiment may include a pressure transducer. Divers may have different time-span hazards associated with diving depths, for example. In various embodiments, the timer may have data relating to dissolved nitrogen as a function of pressure, which may correlate to diving depth. The timer may simply begin automatically at a predetermined pressure, for example. The timer face may blink green when the diver begins to ascend. The timer face may change color to indicate to the diver that the diver should slow or stop. For example, a yellow LED may indicate for the diver to slow the ascent, and a green LED may indicate for the diver to stop the ascent. The timer may then change to green when it is safe for the diver to ascend again. This may continue until the diver reaches the surface.

Some embodiments may be used as interval timers for athletic training, for example. In such an embodiment, the time spans may vary between long time spans and short time spans, for example. An athlete may use a programmable multi-time-span timer to programming a training regime, for example. The timer may indicate alternately time a 75 second span for a runner to run a quarter mile and a 60 second rest time, for example.

Some aspects of embodiments may be implemented as a computer system. For example, various implementations may include digital and/or analog circuitry, computer hardware, firmware, software, or combinations thereof. Apparatus elements can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Some embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example and not limitation, both general and special purpose microprocessors, which may include a single processor or one of multiple processors of any kind of computer. Generally, a processor will receive instructions and data from a read-only memory or a random access memory or both. The essential elements of a computer are a processor for executing instructions and one or more memories for storing instructions and data. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and, CD-ROM and DVD-ROM disks. The processor and the memory can be supplemented by, or incorporated in, ASICs (application-specific integrated circuits). In some embodiments, the processor and the member can be supplemented by, or incorporated in hardware programmable devices, such as FPGAs, for example.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. An exemplary embodiment may be implemented in a computer system that includes a graphical user interface and/or an Internet browser. To provide for interaction with a user, some implementations may be implemented on a computer having a display device, such as an LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, and the computers and networks forming the Internet. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, or multiplexing techniques based on frequency, time, or code division. Some implementations may optionally incorporate features such as error checking and correction (ECC) for data integrity, or security measures, such as encryption (e.g., WEP) and password protection.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. A perishable-food timer for indicating the elapsed time of storage of a perishable-food item, the perishable-food timer comprising:
a input control device, configured to accept inputs from a user;
an elapsed-time counter coupled to the input control device and configured to be supplied power by a battery, the elapsed-time counter counts the elapsed time as measured from the time a begin-count-mode command is input by the user to the input control device;
a display face comprising three display regions, a first display region indicating to the user that the timing is for storage of the perishable-food item in a room-temperature environmental climate, a second display region indicating to the user that the timing is for storage of the perishable-food item in a refrigerator environmental climate, and a third display region indicating to the user that the timing is for storage of the perishable-food item in a freezer environmental climate;
an attachment device coupled to the display face, the attachment device configured to releasably attach to the perishable-food item; and
a plurality of LEDs positioned in consecutive adjacent-in-space locations of the display face, wherein each of the plurality of LEDs has a one-to-one correspondence to consecutive adjacent-in-time time-spans,
wherein each time-span has a beginning elapsed-time count and an ending elapsed-time count,
wherein one of the plurality of LEDs is an active LED, the active LED is the LED that corresponds with the time-span having a beginning elapsed-time count less than the counted elapsed time and having an ending elapsed-time count greater than the counted elapsed time,
wherein the first display region comprises a first subset of the plurality of LEDs, the first subset comprising those LEDs corresponding to time-spans having an ending elapsed-time count less than or equal to a room-temperature spoilage time corresponding to the perishable food item,
wherein the second display region comprises a second subset of the plurality of LEDs, the second subset comprising those LEDs corresponding to time-spans having a beginning elapsed-time count greater than or equal to the room-temperature spoilage time, and having an ending elapsed-time count less than or equal to a refrigerated spoilage time corresponding to the perishable food item,
wherein the third display region comprises a third subset of the plurality of LEDs, the third subset comprising those LEDs corresponding to time-spans having a beginning elapsed-time count greater than or equal to the refrigerated spoilage time, and having an ending elapsed-time count less than or equal to a frozen spoilage time corresponding to the perishable food item.

2. The perishable food timer of claim 1, wherein if the active LED is one of the first subset of the plurality of LEDs, the active LED periodically flashes.

3. The perishable food timer of claim 1, wherein if the active LED is one of the third subset of the plurality of LEDs, the active LED periodically flashes if an illuminate-LED command is input by the user to the input control device.

4. The perishable food timer of claim 1, wherein the attachment device is a snap ring.

5. The perishable food timer of claim 1, wherein the attachment device is an elastic band.

6. The perishable food timer of claim 1, wherein each of the LEDs of the first subset corresponds to a time span of one hour, wherein each of the LEDs of the second subset corresponds to a time span of one day, and wherein each of the LEDs of the third subset correspond to a time span of one month.

7. The perishable food timer of claim 1, wherein the plurality of LEDs comprise different colors, each color indicative of the LED's proximal relation to a last LED in the same display region.

8. An elapsed-time counter for indicating a warning corresponding to a temporal-hazard associated with an object being exposed to a climate environment, the elapsed-time counter comprising:
a input control device, configured to accept inputs from a user;
an elapsed-time processor coupled to the input control device and configured to be supplied power by a battery, the elapsed-time processor measures the elapsed time from the time a begin-count-mode command is input by the user to the input control device;
a display face comprising a plurality of display regions, each display region indicating to the user that the timing measurement corresponds to a climate environment;
an attachment device coupled to the display face, the attachment device configured to releasably attach to the object being exposed to the climate environment; and
a plurality of timing indicators, wherein each timing indicator has a one-to-one correspondence to a time-span, wherein each time-span has a beginning elapsed-time measure and an ending elapsed-time measure,
wherein each of the plurality of timing indicators, which has a corresponding time span having a beginning elapsed-time measure less than the measured elapsed time and having an ending elapsed-time measure greater than the measured elapsed time, is an active timing indicator,
wherein each of the plurality of display regions comprises a subset of plurality of timing indicators.

9. The elapsed-time counter of claim 8, wherein the LEDs comprising each subset of timing indicators are arranged in an ascending fashion according to their corresponding ending elapsed-time measures, wherein a first timing indicator is the timing indicator associated with the lowest ending elapsed-time measure and a last timing indicator is the timing indicator associated with the highest ending elapsed-time measure.

10. The elapsed-time counter of claim 9, wherein the first timing indicator of each of the display regions has an overlapping time span with the first timing indicators of the other display regions.

11. The elapsed-time counter of claim 8, wherein each of the time spans is mutually exclusive with respect to all other time spans.

12. The elapsed-time counter of claim 8, wherein one or more of the plurality of timing indicators comprises light indicators.

13. The elapsed-time counter of claim 12, wherein each of the light indicators is an LED.

14. The elapsed-time counter of claim 13, wherein the LEDs are colored, each color corresponding to a temporal proximity to the temporal-hazard.

15. The elapsed-time counter of claim 8, further comprising an audible signal generator.

16. The elapsed-time counter of claim 8, wherein at least one of the timing indicators corresponds to a time-span having a beginning elapsed-time measure greater than three months.

17. An elapsed-time counter for indicating a warning corresponding to a temporal-hazard associated with an object being exposed to a climate environment, the elapsed-time counter comprising:
a input control device, configured to accept inputs from a user;
an elapsed-time processor coupled to the input control device and configured to be supplied power by a battery, the elapsed-time processor measures the elapsed time from the time a begin-count-mode command is input by the user to the input control device;
a display face comprising a plurality of display regions, each display region indicating to the user that the timing measurement corresponds to a climate environment;
means for releasably attaching the elapsed-time counter to the object being exposed to a climate environment; and
a plurality of timing indicators, wherein each timing indicator has a one-to-one correspondence to a time-span, wherein each time-span has a beginning elapsed-time measure and an ending elapsed-time measure,
wherein each of the plurality of timing indicators, which has a corresponding time span having a beginning elapsed-time measure less than the measured elapsed time and having an ending elapsed-time measure greater than the measured elapsed time, is an active timing indicator,
wherein each of the plurality of display regions comprises a subset of the plurality of timing indicators arranged in an ascending fashion according to their corresponding ending elapsed-time measures, wherein a first timing indicator is the timing indicator associated with the lowest ending elapsed-time measure and a last timing indicator is the timing indicator associated with the highest ending elapsed-time measure.

18. The elapsed-time counter of claim 17, wherein means for releasably attaching the elapsed-time counter to the object being exposed to a climate environment comprises a snap-ring.

19. The elapsed-time counter of claim 17, wherein means for releasably attaching the elapsed-time counter to the object being exposed to a climate environment comprises an elastic band.

20. The elapsed-time counter of claim 17, wherein means for releasably attaching the elapsed-time counter to the object being exposed to a climate environment comprises means for attaching the elapsed-time counter to the object, and means for releasing an attached elapsed-time counter from the object to which it is attached.
